(19) United States
(12) Patent Application Publication
(10) Pub. No.: US 2007/0163964 A1
(43) Pub. Date: Jul. 19, 2007

(54) Methods and compositions for filtration media

(76) Inventors: J. Kelly Williamson, Chattanooga, TN (US); Eric Rominger, Chattanooga, TN (US); Mark B. Miller, Chattanooga, TN (US)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 11/593,750

(22) Filed: Nov. 7, 2006

Related U.S. Application Data
(60) Provisional application No. 60/734,240, filed on Nov. 7, 2005.

(51) Int. Cl. B01D 21/01

(52) U.S. Cl. 210/736

(57) ABSTRACT

The present invention comprises methods and compositions for treating water. Compositions comprise filtration media having antimicrobial and biocidal properties for use in filtering particles and deactivating, removing and/or destroying microorganisms in a liquid. Filter media suitable for use in the present invention include perlite contacted by organosilane compositions.

### RELATED U.S. APPLICATION DATA

The present application claims priority to the Nov. 7, 2005 U.S. Provisional Application No. 60/734,240, which is incorporated herein by reference.

### FIELD OF THE INVENTION

The present invention is directed to filtration media with antimicrobial properties. In particular, the present invention is directed to making and using filtration media with aqueous antimicrobial compositions comprising organosiloxane quaternary ammonium compounds. The filtration media of the present invention may be used for filtration of water to remove or kill microorganisms in the water.

### BACKGROUND OF THE INVENTION

The treatment of “non-point source” water pollution such as stormwater and industrial runoff is a growing concern for urban centers, industrial sites, and residential property owners. Increasingly, government entities are instituting strict regulations for treatment and disposal of stormwater and industrial runoff. Despite increasing public concern and government issues surrounding this issue, current technology does not adequately meet the current needs. Stormwater and industrial runoff can be highly contaminated with a highly variable mix of particulate and dissolved contaminants. In many circumstances, runoff flow occurs intermittently and in high volume requiring rapid, but effective, treatment and removal of the various contaminants, which may include human and animal waste, organic chemicals, pesticides, oils, solids (particulates and dissolved), heavy metals, and fertilizers.

Microbial contaminants from sewage, human waste and animal waste, including bacteria, viruses, fungi, and other disease organisms, are of particular concern. Although urban runoff has been found to contain Salmonella, the occurrence of Salmonella in urban runoff is generally low. Of greater concern are pathogenic organisms which are infective at a low organism concentration or whose mode-of-entry is not oral ingestion. These pathogens include, but are not limited to Pseudomonas aeruginosa, Staphyloccus aureus, Escherichia coli, Shigella, or enteroviruses. Pseudomonas is reported to be the most abundant pathogenic bacteria present in urban runoff and streams, with several thousand P. aeruginosa organisms per 100 mL being common. Relatively small populations of P. aeruginosa may cause health problems simply through water contact, and such bacteria are typically resistant to antibiotics. The presence of enteroviruses in urban runoff is of concern since very small virus concentrations are capable of producing infections or diseases. Recent studies have shown, for example, that swimmers at beaches located near stormwater outfall show an increased risk of a variety of health problems.

Despite the health concerns surrounding stormwater and industrial runoff, particularly related to microbial contamination, there exists a need for economic and effective methods to treat runoff for microbial contamination. Currently, if runoff is treated at all, it is handled by filtration, typically using filtration media such as sand, compost, fibers, fabrics, peat and other elaborate filtration systems. While these filtration media may often be effective in handling many target pollutants such as total suspended solids, soluble heavy metals, oil and grease, these media are less effective for removing microbial contaminants. Microbial contaminants may be removed from aqueous solutions by filtration through filters with very small pore sizes, typically 0.4 microns or less. However, the use of such filter media for stormwater runoff is not desirable because of the poor flow characteristics such media are too slow and prone to fouling by larger particulates.

What is needed are methods and compositions for treatment of water sources that are capable of controlling or killing a broad spectrum of biological agents, including viruses, bacteria and other microbial agents. The treatments should also be stable, have good flow characteristics, be durable with a long lasting effect, safe and non-toxic.

### DETAILED DESCRIPTION

The present invention comprises methods and compositions for treatment of water including but not limited to storm water runoff, industrial liquid discharge, sewer water discharge, catch basins, livestock water holding ponds, and livestock waste lagoons. The compositions of the present invention comprise compositions comprising organosilane quaternary amine compounds and quaternary ammonium compounds, admixed with perlite. The present invention comprises treating perlite filtration media with biocidal or antimicrobial compositions of the present invention to make a biocidal or antimicrobial filtration media and methods for using the biocidal or antimicrobial filtration media.

The present invention comprises biocidal compositions comprising an organosilane quaternary amine compound and at least one additional biocidal active compound. The at least one additional biocidal active compound is one or more compounds includes, but is not limited to, quaternary ammonium compounds, such as chloride and saccharinate quaternary ammonium compounds from Lonza or Stepan Co., antibiotics, antivirals, antifungals, and antimicrobials.

Compositions of the present invention may further comprise stabilizer compounds. Several compounds and methods of stabilizing organosilane quaternary compounds are known in the art, and include methods described in U.S. Pat. Nos. 5,954,869; 5,959,014; 6,120,587; 6,113,815; 6,469,120; and 6,762,172. In one embodiment, the organosilane quaternary compound may be stabilized by the reaction in propylene carbonate. An advantage of stabilized organosilane quaternary compounds is the ability to deliver silanes in an aqueous solution to commonly encountered surfaces. Compositions used in methods of the present invention may also comprise an organosilane quaternary ammonium compound and an organosilane provided in emulsions such as those taught in U.S. Pat. Nos. 4,908,355 and 6,607,717, which are incorporated herein by reference.

Compositions of the present invention may comprise an organosilane quaternary compound and a quaternary ammonium compound, which when combined can provide contact disinfection and residual antimicrobial activity; and may further comprise an oxidizing agent and a chelating agent, and water or other solvent. Examples include, but are not limited to, compositions wherein the oxidizing agent is hydrogen peroxide and the chelating agent is EDTA.

The present invention comprises compositions comprising an organosilane quaternary compound and a quaternary ammonium compound, and may further comprise an oxidizing agent or a chelating agent, and may optionally comprise a surfactant; a wetting agent; an antibiotic compound, antifungal agent, or an antiviral agent. Compositions of the present invention also comprise an organosilane quaternary compound and may further comprise one or more of, a surfactant; a wetting agent; an antibiotic compound, antifungal agent, an antiviral agent, an oxidizing agent or a chelating agent.

The compositions of the present invention comprise a ratio of organosilane quaternary compound to one or more quaternary ammonium compounds in a weight range of 1:100 to 100:1 or in a weight range of 1:10 to 10:1. The ratio of organosilane quaternary compound to one or more quaternary ammonium compounds may be determined by the particular use of the composition or final product or the surface or material to which the composition is to be applied, as well as the specific nature of the microbial contamination or potential microbial contamination.

Compositions may comprise water, an aqueous or non aqueous solvent, or combinations or aqueous and nonaqueous solvents in a range between about 50% to about 80%, by weight; organosilane quaternary compound in a concentration range of about 0.001% to about 85%; one or more quaternary ammonium compounds in a concentration range of about 0.001% to about 10%; and optionally, chelating agent such as EDTA in a concentration range of about 0% to about 5%; reducing agent such as hydrogen peroxide in a concentration range of about 0% to about 5%; solubility enhancing agents or other formulation agents such as isopropyl alcohol in a concentration range of about 0% to about 10%, solvent enhancers such as glycol ether in a concentration range of about 0% to about 10%; and wetting agents such as NP-9 (Nanophenol Ethoxylate-9) in a concentration range of about 0% to about 10%.

A composition may comprise about 60-90% water; an organosilane quaternary compound in a concentration range of about 0.001% to about 6%; one or more quaternary ammonium compounds in a concentration range of about 0.001% to about 5%; EDTA at a concentration of range of about 0.1% to about 3%; hydrogen peroxide at a concentration range of about 0.01% to about 3%; isopropyl alcohol at a concentration range of about 5% to about 7%; Glycol Ether DB at a concentration range of about 0.1% to about 7%; and NP-9 at a concentration range of about 0.1% to about 4%.

Organosilane quaternary compounds of the present invention include compounds taught by U.S. Pat. Nos. 5,954,869; 5,959,014; 6,120,587; 6,113,815; 6,469,120; and 6,762,172, all of which are incorporated herein by reference, and include the AM500 product line of BioShield Technology, Inc., the antimicrobial products of Nova Biogenetics, Inc. and SiShield, Inc. of Norcross, Ga., and the Aem5700 antimicrobial products of Aegis Environmental.

As used herein, the term surfactant (or surface-active agent) refers to any compound which, when dissolved in water or a water-containing solution, reduces surface tension of the solution or the interfacial tension between water or the water-containing solution and another liquid, or between water, a water-containing solution, or another liquid and a solid. Surfactants can be classified as anionic, zwitterionic or non-ionic, depending on the overall charge that the molecule carries.

The surfactant can optionally be present in the composition of the present invention in amounts of from about 0% to about 30% by weight, or from about 0.1% to 15% by weight or from about 2% to about 10%, or from about 1.0% to about 5.0% by weight.

Chelating agents of the present invention include inorganic and organic compounds. The chelating agent used may depend upon the specific application. Application specific concerns include cost, nature of the metal ions to be chelated, compatibility with the components of the composition, and solubility in the composition. Chelating agents of the present invention are generally non-toxic to animals and humans in the amounts described herein. One skilled in the art would be able to appreciate these parameters and select the appropriate chelating agent without undo experimentation.

In one embodiment, chelating agents of the present invention would have a complex formation equilibrium constant of about 10⁷ to about 10²⁷. In another embodiment, the chelating agent used in the composition has a complex formation constant of about 10⁷, 10⁸, 10⁹, 10¹⁰, 10¹¹, 10¹², 10¹³, 10¹⁴, 10¹⁵, 10¹⁶, 10¹⁷, 10¹⁸, 10¹⁹, 10²⁰, 10²¹, 10²³, 10²⁴, 10²⁵, 10²⁶, and 10²⁷.

A safe and effective amount of one or more chelating agents may be added to the compositions of the present invention, and when present comprising about 0.1% to about 10% by weight of the composition. In another aspect, the composition comprises from about 1% to about 5% by weight of each of at least one chelating agents. In yet another aspect, the biocidal composition comprises from about 1% to about 5% by weight of a single chelating agent. In one embodiment, the biocidal composition comprises, by weight, about 0.50%, 0.75%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, and 5.0% of one chelating agent. In a further aspect, the biocidal composition comprises, by weight, about 0.50%, 0.75%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, and 5.0% of the combination of all chelating agents, wherein the composition comprises two or more chelating agents.

In one aspect, exemplary chelating agents of the present invention include, but are not limited to, ethylenediamine tetraacetic acid (EDTA) or its salts (e.g. EDTA, sodium salt), and may comprise a composition comprising, by weight, about 0.50%, 0.75%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, and 5.0% of EDTA.

In general, a reducing agent is a chemical which can provide an electron, or be an electron donor. Reducing agents in the present invention include, but are not limited to, hydrogen peroxide.

Solid or filter media suitable for use in the present invention include, but are not limited to, siliceous materials such as perlite, ceramic spheroids, hollow glass spheres, polymeric type media, sand, zeolites and thermoset coated glass spheres. Perlite is a generic name for a naturally occurring volcanic glass that when heated, expands from four to twenty times its original volume. Perlite is generally referred to as course (grain size 1.5 mm-6.0 mm), normal/medium (0.1-3.0 mm), and fine/very fine(0.0-0.2 mm). It is composed primarily of silicon(SiO₂), 72-76%, free moisture-0.5%, aluminum(Al₂O₃): 11-17%, calcium(CaO): 0.5-2.0%, Magnesium(MgO), Iron (Fe₂O₃): 0.5-1.5%, Potassium 4-5%, Sodium: 3-4%.

In general, an antimicrobial or biocidal filtration media is made by admixing a composition comprising an aqueous solution of at least an organosilane compound and a solid material, such as perlite, for an amount of time sufficient for the solid to contact the organosilane compound. Any of the compositions taught herein can be used in the methods for treating the solid filtration media. The filtration media may be pretreated or may not be pretreated. Dyes may be added to the compositions for visual confirmation of presence of the composition on the solid media. Initial treatments may be applied by one method, such as complete immersion of the solid in a solution, and subsequent treatments may be by spraying, or running solution through the solid media while in situ. Multiple or repeated treatments in the field or by its removal and retreatment treatments of filtration media over many years of use of the media are contemplated by the present invention.

For example, expanded perlite siliceous rock (coarse type) was mixed in an aqueous solution containing a stabilized organosilane quaternary compound for a time sufficient to allow the compound to contact the perlite material, part A. Part A was prepared to form an antimicrobial effective complex comprising (0.75% TMSQ & 99.25% D.I. water solution by weight, which makes this solution ¾% active by w/v). A second composition that has both disinfectant (contact efficacy) and residual antimicrobial efficacy, and which comprises about 1% active by weight (part B), was added to part A while contacting the perlite. In general, this second solution is added at a ratio of 2 parts A to 1 part B. The perlite was mixed and agitated in the combined aqueous solution for at least several minutes to allow contact. Other methods for contacting the solid material and the solutions are contemplated by the present invention and include, but are not limited to, spraying, forced immersion, and centrifugal inundation. The treated perlite then was drained and removed to dry at room temperature. Other drying methods can also be employed.

Methods of the present invention comprise using the treated filtration media to treat waters of any kind to render the water substantially free of microbial contamination. The compositions of the present invention may be used to treat solid filtration media to render such media antimicrobial or biocidal so that such antimicrobial or biocidal filtration media may be used in treatment of water. Treatment of water includes use of the solid media to remove particulates from the water and also includes antimicrobial and biocidal activity whereby microbial lifeforms are killed or inhibited from growing. Any channeled or contained waters are contemplated by the present invention, including but not limited to; contained water for swimming pools, spas, cooling towers; storm water runoff, industrial liquid discharge, sewer water discharge, catch basins, livestock water holding ponds, and livestock waste lagoons.

Uses of antimicrobial treated solid media or other surface for any physical, chemical and mechanical means of eliminating bacteria and other microorganisms from water including but not limited to: storm waters. stagnant or low flow water conditions in catch basins, storm water pipes. pools, spas, waste lagoons, such as those used in agriculture in the cattle, poultry, aquarium, fish farms; industrial liquid discharge; municipal waste water reprocessing plants; raw water before and after treatment; sewer discharge; food and beverage processing plants discharge; cooling towers and hot water systems in buildings; drinking water pipes and water distribution system; water filtration systems of any size; bottled waters; waters used in the healthcare area; waters for research or high purity requirements; treatment of leachate or hazardous waste water; marine desalinization, marine graywater; military applications of all of these types; drinking and potable water; surface water treatment; and cleanup after flooding. Examples of uses of the antimicrobial perlite filtration media of the present invention include use in the Aqua-Filter™ Filtration System (AquaShield, Inc.), a two component in-line treatment train, for removal of gross contaminants, very fine sediments, water-borne hydrocarbons, heavy metals and nutrients such as phosphorous and nitrogen; and, the Aqua-Guard™ Catch Basin Insert (AquaShield, Inc.), which removes gross contaminants, oil and sediment at the source. Other commercial applications in which the present invention could be employed include, but is not limited to, filtration systems of Stormwater Management; Vortechnics (Stormwater 360 under ConTech) CDS media filtration system, The Schundler Co.; General Filtration; Lenntech Water Treatment; Filtrox AG; Aqua-Perl; and Pall Corporation.

The present invention comprises methods of treating water, by contacting the water with a solid surface having a composition taught herein adhered thereto. For example, the water is storm water runoff and the solid surfaces are in treatment systems are canisters, containers, tins, flasks, cylinders, cartridges, bags, beds, layers, fabric, textile, sheets, capsules, baskets, socks, booms, pillows, pipes, screens, panel, guard, shield, patrician, barrier, dividers, weirs, baffles, drip trays, packet, tablets, wafers, sachets, pocket, or tubes. For example, the water treated is industrial runoff and discharge from drain piping to point discharge such as sheet flow to open swales, ditches, or conveyances. For example, the water is agricultural runoff and discharge, and involves drain piping to point discharge, or sheet flow to open swales, ditches, or conveyances.

The methods of the present invention comprise treatment of water. Compositions of the present invention comprise filtration media comprising solid materials such as perlite, and organosilane quaternary compound and quaternary ammonium compound compositions taught herein, referred to as treated filter media that is antimicrobial or biocidal, for rendering the water free of microbial contamination. Such treated filter media may be used in known commercial filters and under a wide variety of filtering conditions. For example, the methods include filtering water at flow rates of greater than 5, 10, 15, 20, 25, or 30 gal/sq.ft. per minute. These flow rates are achievable with gravity flow and do not require pressurization or mechanical pumping through the filtration step. The water that is filtered over or through the treated perlite is capable of rendering the water free of a degree of microbial contamination for a period time. For example, the treated perlite may be capable of rendering the water free of at least 50% of the microbial contamination, at least 60%, at least 80%, at least 90% or at least 95% of the microbial contamination of the water. A filter comprising the treated perlite may be effective at rendering the water free of microbial contamination to such a degree for a period of time of at least one month, two months, three months, four months, five months or longer without being retreated or contacting the perlite with an organosilane composition again.

Additional examples include water treatment of sanitary discharge from on site or extended septic treatment systems including but not limited to single family homes; large multi-unit dwellings; industrial (rural plants and factories, schools); commercial sites, combined Sewer Overflow (CSO) Municipalities (these “combine” or carry stormwater runoff into the sanitary system which often overflows when large storm events overwhelm the piping structure thus sending raw sewage into receiving waters); and Municipal Sanitary Sewer Discharges (sanitize before release into receiving water body). Other methods of water treatment include treatments of water used in food processing such as washing food, meats, vegetables, misting of food at groceries, and includes treating the water before and after washing the food items. Other uses include treatment of water that may be contaminated by microorganisms removed from water by bodily contact such as by contact from oral hygiene treatments at the dentist offices or in home uses; physician or other medical offices and hospitals, field and emergency response and other health care situations. Both in providing water to such sites and water discharged from procedures that clean or irrigate wounds, or other body surfaces. This prevents health care workers from handling and disposing of bacteria contaminated water reducing their risks of infection or spread of the virus.

Additionally, the present invention is useful in providing clean water, or in cleaning water to provide potable water at disaster sites or for providing sanitary water treatment systems. For example, the methods and compositions of the present invention can be used by emergency response and disaster relief sanitary water treatment teams with a mobile or transportable system to aid FEMA, State EMA's, Civil Defense, and other first responders. Such systems may be mobile and can be flown or driven to sites or air dropped for emergency situations.

The present invention is also useful for controlling microbial growth and treatment of standing water in heating and cooling systems. Such treatments include heat and air conditioning systems; cooling towers in industrial, commercial, or office complexes; home HVAC units that are currently using UV light to disinfect mold, bacterial slim, mildew from condensate/drip pans, boiler/heat energy re-processed water. Other applications include treatment of water wells including wells that are private; public; drinking; agricultural; industrial. There are also recreational uses for the present invention such as treatment of water for use in recreational vehicles, house boats, and water for camping and hiking,

The antimicrobial filter media of the present invention is effective for deactivating, killing, inhibiting, destroying and/or removing from a liquid, such as water, microbial lifeforms including but not limited to bacteria, fungi, viruses, parasites, eubacteria, rotifers, phytoplankton, plankton, and spores, from species such as Escherichia coli, Salmonella choleraesuis, Staphylococcus, Aspergillus, Klebisiella, Listeria clostridium, rotavirus, cysts and other microorganisms. Moreover, the filter media can be used repeatedly without a decrease in antimicrobial and biocidal effectiveness.

As used herein, the terms antimicrobial and biocidal are overlapping and interchangeable terms, and are intended to encompass both the ability to kill and inhibit the growth of microbial lifeforms.

As used herein, optional or optionally means that the subsequently described event or circumstance may or may not occur, and that the description includes instances where said event or circumstance occurs and instances where it does not. For example, the phrase optionally substituted lower alkyl means that the lower alkyl group may or may not be substituted and that the description includes both unsubstituted lower alkyl and lower alkyl where there is substitution.

By the term effective amount of a compound, product, or composition as provided herein is meant a sufficient amount of the compound, product or composition to provide the desired result. As will be pointed out below, the exact amount required will vary from substrate to substrate, depending on the particular compound, product or composition used, its mode of administration, and the like. Thus, it is not always possible to specify an exact effective amount. However, an appropriate effective amount may be determined by one of ordinary skill in the art using only routine experimentation.

As used herein, the term suitable is used to refer a moiety which is compatible with the compounds, products, or compositions as provided herein for the stated purpose. Suitability for the stated purpose may be determined by one of ordinary skill in the art using only routine experimentation.

As used herein, substrate refers to any article, product, or other surface that can be treated with the inventive compounds. Suitable substrates are generally characterized in preferably having a negatively charged surface of oxygen atoms, or any surface capable of electrostatically, ionically or covalently adhering or binding to the compounds, products, or compositions of the present invention. The adhering or binding may occur at the silicon atom of the organosilane portion of the compounds, products, or compositions of the present invention, but such binding is not a requirement. Therefore, as used herein, the term adhere is meant to refer to ionic, covalent, electrostatic, or other chemical attachment of a compound, product or composition to a substrate.

As used herein, the term biocidal is used in its general sense to refer to the property of the described compound, product, composition or article to kill, prevent or reduce the growth, spread, formation or other livelihood of organisms such as bacteria, viruses, protozoa, fungi, molds, algae, or other organisms likely to cause spoilage, disease or infection.

As used herein, the term stabilizer is used to refer to the class of polyols as specified herein wherein any two of the at least three hydroxy groups are separated by at least three atoms. Such compounds have been found to stabilize the organosilanes by preventing self-condensation or other inactivation of the resulting compounds and products.

It is to be understood that the terminology used herein is for the purpose of describing particular embodiments only and is not intended to be limiting. It must be noted that, as used in the specification and the appended claims, the singular forms a, an and the include plural referents unless the context clearly dictates otherwise.

Throughout this application, where publications are referenced, the disclosures of these publications in their entireties are hereby incorporated by reference into this application in order to more fully describe the state of the art to which this invention pertains.

The following Examples are provided as illustrative of the uses and applications of the present invention to add one skilled in the art. The Examples are not to be considered limiting or restricting to the uses of the present invention.

### EXAMPLES

### Example 1

### Preparation of Perlite Antimicrobial Filtration Media with Antimicrobial Properties

350 grams of expanded coarse perlite (8.0 -12.0 pounds per cubic foot) was mixed with stirring solution comprising 0.75% (w/v) water-stabilized 3-(trimethoxysilyl)propyl-dimethyloctadecyl ammonium chloride (TMSAC). The pH of the treatment solution was about 6.5. The amount of perlite used was about 1 liter, and the amount of TMSAC used was about 1 gallon. Initially, the perlite was manually submerged. The temperature of the solution was about 70-75° C.

After stirring the perlite and TMSAC solution for 15-30 minutes, an equal volume of a second solution was added and stirring was allowed to continue for an additional 15-30 minutes. The second solution was:

| Component | Percent (w/w) |
|---|---|
| 3-(trihydroxysilyl) propyldimethyl | 0.50 |
| octadecyl ammonium chloride | |
| N,NDiakyl(C8-C10)-N,N- | 0.75 |
| dimethylammonium chloride | |
| N-Alkyl(50% C14, 40% C12, 10% C16) | 0.75 |
| dimethylbenzylammonium chloride | |
| Isopropyl alcohol | 0.75 |
| Glycol Ether EB | 0.75 |
| Barlox | 0.67 |
| EDTA | 0.25 |
| T-NP-9.5 Surfactant | 0.38 |
| Water | 95.20 |

The perlite was then removed from the solution and was dried at room temperature.

### Example 2

### Evaluation of Antimicrobial Perlite Filtration Media of E. coli

Antimicrobial filtration media was prepared as described in Example 1. The antimicrobial filtration media filled a 1.5 inch diameter media cartridge 12 inches in length. The volume of the cartridge, 21.24 square inches, contained 82 grams of antimicrobial filtration media. Prior to testing, the cartridge was flushed with 42 gallons of laboratory reagent grade water. The 42 gallons of water flushed through the cartridge roughly translates to what would pass a 24 square foot system, 12 inches deep over a three month period at a flow rate of 407,300 gallons per year. For this test, an E. coli stock was prepared from a KWIK-STIK pellet, traceable to authentic references collections such as the American Type Culture Collection. The pellet was reconstituted in water in a volume of 10 ml, from which a 1.0 ml sample was removed and placed into one gallon HDPE containers. The containers were filled with sterile water to a volume of 1 gallon and gently shaken for 10 minutes. The resulting solution constitutes the E. coli simulation solution. A 100 ml sample of the E. coli simulation solution was removed and analyzed for E. coli concentration.

The E coli samples were tested as per “Methods for the Examination of Water and Wastewater”, 18^{th} Edition, (1992). Test Method Number: 9260F. Samples were analyzed within appropriate holding times for each method. Internal blanks and standards were analyzed with the simulations as part of a standard QAQC program. A finding of <1 colony E. coli per 100 ml is essentially considered “None Detected” as 1 is the method detection limit for method 9260F.

The test apparatus used for this experiment consists of five basic components. A 2 gallon, conical bottom, polypropylene tank contained the influent. Discharge from the holding tank into the media cartridge was a direct gravity feed regulated by a flow valve at the bottom of the holding tank. The media cartridge was a PVC cylinder, 1.5 inches diameter and 12 inches in length. A flexible nylon screen (1 mm square openings) held in place with open PVC end caps retained the encased perlite media. The effluent was collected from the cartridge in a 2 gallon polypropylene container. The E. coli simulation solution was delivered into the media cartridge at a flow rate that maintained a 3 inch headspace. A control sample was removed from the E. coli simulation solution to passing the solution through the cartridge media. The collected post-cartridge effluent sample, along with the control sample, was immediately analyzed for E Coli.

Previous testing indicated that E. coli coliforms were being killed and not physically removed or filtered during the described simulation sample testing. Standard E. coli bacteria are approximately 1 to 2 microns in length and 0.5 to 1 microns in length and would easily pass the perlite cartridge. The control taken from the E. coli simulation solution prior to testing contained approximately 1180 colonies per 100 ml. The post-cartridge effluent sample contained <1 colony per 100 ml. The simulation roughly estimates a three month period based on a flow of 407,300 gallons a year through a 24 square foot system, 12 inches deep. The actual gallon simulation passed the filter at approximately 30 gallons per minute per square foot.

The results indicate that filtration of water containing E. coli through a cartridge containing antimicrobial filtration media effectively suppressed >99% E Coli at a flow rate approximately 30 gallons per minute per square foot.

### Example 3

### Evaluation of Antimicrobial Perlite Filtration Media for the Removal of E. coli

Independent laboratory bench scale tests assessed the efficacy of a treated coarse perlite filter media cartridge to remove TSS (Total Suspended Solids) and E. coli from simulated stormwater standard. Ten runoff simulations were performed using 100 mg/L of TSS with an average particle size of ˜20 microns and a stock E. coli was selected as product microorganism, repeatable and reproducible solution containing 150 colonies per 100 ml and gravity fed at a flow rate approximately 18 to 19 gpm/ft² maintaining a headspace at 3 inches.

The results indicated that the antimicrobial filtration media effectively removed or suppressed >80% TSS and >99% E. coli.

### Example 4

### Evaluation of Antimicrobial Perlite Filtration Media for the Removal of E. coli

An additional test to evaluate the efficacy of the coarse perlite filter media cartridge with a higher concentration of E. coli at a higher flow rate over a longer period of time was performed. Prior to testing, an additional 42 gallons of laboratory reagent grade water was flushed the over the already tested 10 gallons of simulation from Example 3. These 42 gallons represent approximately 3 months of rainfall over a 1-acre site receiving an annual rain event of 15 inches or 407,300 gallons passing a 24 ft² filtration treatment system 12 inches deep over 12 months. A stock E. coli was selected as a product microorganism, in a repeatable and reproducible solution containing 1180 colonies per 100 ml and was gravity fed at a flow rate of about 30 gpm/ft² maintaining a headspace of less than 3 inches.

Tests concluded that the E.coli removal efficiency was >99%.

### Example 5

### Evaluation of Antimicrobial Perlite Filtration Media

Independent laboratory bench scale tests assessed the efficacy of an antimicrobial coarse perlite filter media cartridge to remove 42 gallons of E. coli from a simulated stormwater event. A stock E. coli was selected as product microorganism, and a repeatable and reproducible solution containing 4300 colonies per 100 ml was gravity fed at a flow rate approximately 15 to 18 gpm/ft², maintaining a headspace <3 inches. Pre- and post-cartridge samples were taken every 1, 10, 21, 32, and 42 gallons. This represents ˜2.4 months of rainfall over a 1-acre site that would receive an annual rain of 15 inches or 407,300 gallons passing a 24 ft² treatment system 12 inches deep over 12 months. The results indicated that the treated coarse perlite effectively removed 99.9% E. coli.

### Example 6

### Evaluation of Antimicrobial Perlite Filtration Media for the Removal of E. coli

For this laboratory bench test, 42 gallons of a stock solution having an E. coli concentration of 2,120 colonies per 100 ml was gravity fed from top to bottom through a perlite filter media cartridge of the type described in Example 2, the perlite filter media being treated with an antimicrobial composition as described herein. The solution was fed at a flow rate of 9 gpm/ft². Samples were analyzed from the 1^{st}, 10^{th} and 42^{nd} gallons of solution and over 99.9% of the E. coli were eliminated from the stock solution in each test sample. Since the same filter media cartridge configuration was used as in Example 5, the 42 gallon test represents ˜2.4 months of rainfall over a 1-acre site that would receive an annual rainfall of 15 inches or 407,300 gallons passing a 24 ft² treatment system 12 inches deep over 12 months.

### Example 7

### Evaluation of Antimicrobial Perlite Filtration Media for the Removal of High Concentration E. coli in Upflow Filtration

A laboratory bench test was devised to test for removal of E. coli at concentrations representative of sanitary applications utilizing upflow filtration. For this test, perlite filtration media was treated with an antimicrobial composition and used to fill a 6 inch diameter filter cartridge, of approximately 0.75 inches in depth, for a total volume of 21.24 inches. The is the same volume as utilized in examples 2 through 6, although in a flatter configuration. A stock solution was prepared having a E. coli concentration of 2,950 colony forming units per 100 ml. The stock solution was gravity fed from a holding tank into the media cartridge at its base. The solution flowed from bottom to top through the perlite filter media cartridge. The perlite was held in place by flexible nylon fabric, while a delivery nozzle atop the cartridge allowed the filtered solution to exit the top of the cartridge for collection. The 5^{th}, 10^{th}, 20^{th} and 41^{st} gallons were analyzed for E. coli. The flow rate for this test was approximately 9.5 gpm//ft². Testing determined that E. coli removal was greater than 99.9% efficient in the fifth and tenth gallons. Samples from these gallons contained less than 1 colony forming unit per 100 ml in gallon 5 and about 2 colony forming units per 100 ml in gallon 10. Efficiency of removal deteriorated slightly, as at gallon 20 there were 3 colony forming units per 100 ml for approximately 99.9% removal efficiency and while the sample from gallon 41 contained 8 colony forming units per 100 ml for approximately 99.7% efficiency.

These tests are summarized in Table 1.

TABLE 1
Test Data Summary

| | | | | | | Media Cartridge |
|---|---|---|---|---|---|---|
| | E. Coli Concentration | | Flow Rate | | Media Cartridge | Dimension - |
| Example No. | cfu/100 ml | Efficacy | Gpm/ft² | Test Gallons | gm | Inches |
| 3 | 150 | >99.9 | 19 | 10 | 122 | 1.5 d × 12 h |
| 4 | 1,180 | >99.9 | 30 | 42/1* | 82 | 1.5 d × 12 h |
| 5 | 4,300 | >99.9 | 18 | 42 | 78.6 | 1.5 d × 12 h |
| 6 | 2,120 | >99.9 | 9 | 42 | 66.3 | 1.5 d × 12 h |
| 7 | 3,000 | 99.9 to 99.7 | 10 | 42 | 66.3 | 6 d × 0.75 h Upflow |

### Example 8

### Preparation of Perlite Antimicrobial Filtration Media

Perlite was saturated and mixed in plastic jars with AM 500 antimicrobial composition from SiShield. Afterwards, the plastic jars were drained using a nylon screen with 1 mm openings. Perlite in the jars were held in draining position for approximately 24 to 26 hours with temperature between 25 and 30° C. Then to prepare filter media, the perlite was allowed to gravity pack or settle by gently tapping sides of the jars. A test cartridge was prepared with a 4 inch diameter and 2 inch thickness filled with the treated and dried perlite.

### Example 9

### Evaluation of Antimicrobial Perlite Filtration Media AM 500 1:5 (1% active)

The cartridge was prepared as in Example 8 with using AM 500 1:5 (1% active) antimicrobial from SiShield. Then a 42 gallon stock solution was prepared with 2800 colony forming units of E. coli per 100 ml. The stock solution was delivered by gravity feed to the base of the test cartridge providing for an upflow test. The flow rate of the solution was approximately 10.4 gpm/ft². The efficacy of the E. coli removal was tested at the second gallon (99.8% efficacy), 10^{th} gallon (99.6% removal efficacy), 20^{th} gallon (97.9% removal efficacy) and 40^{th} gallon (90.4% removal efficiency). Removal efficacy began to decrease after the 20^{th} gallon to approximately 90% efficacy at the 40^{th} gallon.

### Example 10

### Evaluation of Antimicrobial Perlite Filtration Media AM 500 1:5 (0.5% active)

The cartridge was prepared as in Example 8 with AM 500 1:10 (0.5% active) antimicrobial from SiShield. Then a 42 gallon stock solution was prepared with 3500 colony forming units of E. coli per 100 ml. The stock solution was delivered by gravity feed to the base of the test cartridge providing for an upflow test. The flow rate of the solution was approximately 10.4 gpm/ft². The efficacy of the E. coli removal was tested at the second gallon (99.8% efficacy), 10^{th} gallon (98.8% removal efficacy), 20^{th} gallon (99.3% removal efficacy) and 40^{th} gallon (89.8% removal efficiency). Removal efficacy began to decrease after the 20^{th} gallon to approximately 90% efficacy at the 40^{th} gallon as was the case in Example 9.

### Example 11

### Preparation of Antimicrobial Perlite Filtration Media

A known weight of perlite was mixed with SiShield AM 500 (1:10) to create a saturated slurry with excess AM 500. The slurry was flipped end over end at 32 rpm for 60 minutes in a glass vessel. The vessel was inverted and allowed to gravity drain through a 2.0 mm nylon screen for 24 to 26 hours at a temperature between 25 and 30° C. There was a 21.6% loss in fines or particles less than 2 mm in size. Of the perlite retained by the screen, 1.43 ml of am 500 was used to treat each gram of perlite. The treated perlite media was then placed in a 6 inch diameter media cartridge 0.75 inches in depth. The volume of the cartridge, 21.24 square inches, contained 70.4 grams of treated perlite.

### Example 12

### Evaluation of Antimicrobial Perlite Filtration Media

A stock solution of 43 gallons of water was treated with E. coli pellets to create a liquid 3,800 colony forming units per 100 ml. The test cartridge was connected to a 1,000 gallon tank filled with water that tested negative for both chlorine and E. coli. At a flow rate of approximately 10 gallons per minute per square foot, 100 gallons of rinse water passed the test cartridge. At the 100 gallon mark, the flow was stopped, the cartridge disconnected and attached to the tank containing E. coli stock solution. At an approximately flow rate of 10 gallons per minute, three gallons of E. coli stock solution passed the cartridge. A sample was collected from the third gallon and tested for E. coli suppression. The test cartridge was then reattached to the 1,000 gallon rise tank and the process repeated at the 200, 400 and 800 gallon marks. Both tanks delivered all the stock solution and rise into the cartridge base providing an upflow delivery through the filter. At 100 gallon testing, less than 1 E. coli cfm per 100 ml was detected indicating that greater than 99% efficiency in E. coli reduction. At the 200 gallon test, 740 E. coli cfu per 100 ml was detected indicating approximately 80% removal efficiency. At the 400 gallon test, 3,630 E. coli cfu per 100 ml were detected and at the 800 gallon point 3,800 cfu per 100 ml were detected, indicating little if any suppressive effect.

The upflow delivery of water filtration is generally better controllable in practice, providing more even and uniform media contract than systems using gravity percolation. In addition, because upflow filtration causes perlite filter media to move upward within the filtration canister when water is flowing, and at the conclusion of the flow gravity returns the perlite to a lower position within the canister, the movement prevents channeling in the filter media from continuing between water treatment events.

Whereas this invention has been described in detail with particular reference to specific embodiments, it will be apparent to those skilled in the art that various modifications and variations can be made in the present invention in light of the above teachings without departing from the scope or spirit of the invention. Other embodiments of the invention will be apparent to those skilled in the art from consideration of the specification and practice of the invention disclosed herein. It is intended that the specification and examples be considered exemplary only, with a true scope and spirit of the invention being indicated by the following claims.

What is claimed is:

1. A method for treating water, comprising, contacting water with a perlite filter treated with a composition comprising at least an organosilane quaternary amine compound and a biocidal compound.
